(19) United States
(12) Patent Application Publication
(10) Pub. No.: US 2026/0038173 A1
(43) Pub. Date: Feb. 5, 2026

(54) IMAGE ERASING METHOD, AN APPARATUS, ELECTRONIC DEVICE, AND STORAGE MEDIUM

(71) Applicant: Beijing Zitiao Network Technology Co., Ltd., Beijing (CN)

(72) Inventors: Zhixuan Wei, Beijing (CN); Bo Liu, Beijing (CN); Shuai Li, Beijing (CN); Xinghua Zhang, Beijing (CN)

(21) Appl. No.: 19/281,993

(22) Filed: Jul. 28, 2025

(30) Foreign Application Priority Data
Jul. 30, 2024 (CN) 202411037669.8

(51) Int. Cl. G06T 11/60; G06V 10/26

(52) U.S. Cl. CPC G06T 11/60; G06V 10/26

(57) ABSTRACT

The present disclosure relates to an image erasing method, an apparatus, an electronic device, and a storage medium. The method includes: obtaining an original image layer and an occluding image layer, wherein the original image layer includes a target object, and the occluding image layer occludes at least part of the target object; identifying the target object in the original image layer to obtain a first mask; cropping the first mask based on the occluding image layer to obtain a second mask; and erasing a local area of the occluding image layer based on the second mask.

### CROSS-REFERENCE TO RELATED APPLICATION(S)

This application claims priority to Chinese Application No. 202411037669.8 filed in Jul. 30, 2024, the disclosures of which are incorporated herein by reference in their entireties.

### FIELD

The present disclosure relates to the field of image processing technology, and in particular, to an image erasing method, an apparatus, an electronic device, and a storage medium.

### BACKGROUND

In the actual image processing process, users, in pursuit of innovation and personality expression, often use layer material to carry out creative retouching, such that various effects of layers, such as textures, light, patterns or other image components, can be overlaid or blended while preserving core elements of the original image, thereby enriching visual content and creating unique visual effects.

### SUMMARY

The present disclosure provides an image erasing method, an apparatus, an electronic device, and a storage medium.

According to a first aspect, an embodiment of the present disclosure provides an image erasing method. The method includes:
obtaining an original image layer and an occluding image layer, wherein the original image layer includes a target object, and the occluding image layer occludes at least part of the target object;
identifying the target object in the original image layer to obtain a first mask;
cropping the first mask based on the occluding image layer to obtain a second mask; and
erasing a local area of the occluding image layer based on the second mask.

According to a second aspect, an embodiment of the present disclosure further provides an image erasing apparatus. The apparatus includes:
an obtaining module configured to obtain an original image layer and an occluding image layer, wherein the original image layer includes a target object, and the occluding image layer occludes at least part of the target object;
an identification module configured to identify the target object in the original image layer to obtain a first mask;
a cropping module configured to crop the first mask based on the occluding image layer to obtain a second mask; and
an erasing module configured to erase a local area of the occluding image layer based on the second mask.

According to a third aspect, the present disclosure further provides an electronic device. The electronic device includes:
one or more processors; and
a storage apparatus configured to store one or more programs, where
the one or more programs, when executed by the one or more processors, cause the one or more processors to implement the above image erasing method.

According to a fourth aspect, the present disclosure further provides a computer-readable storage medium having a computer program stored thereon, wherein the program, when executed by a processor, causes the above image erasing method to be implemented.

Compared with the prior art, the technical solutions provided in the embodiments of the present disclosure have the following advantages.

In the technical solutions provided in the embodiments of the present disclosure, the original image layer and the occluding image layer are obtained, wherein the original image layer includes a target object, and the occluding image layer occludes at least part of the target object; the target object in the original image layer is identified to obtain the first mask; the first mask is cropped based on the occluding image layer to obtain the second mask; and the local area of the occluding image layer is erased based on the second mask.

### BRIEF DESCRIPTION OF THE DRAWINGS

The accompanying drawings herein, which are incorporated into and form a part of the description, illustrate the embodiments in line with the present disclosure and are used in conjunction with the description to explain the principles of the present disclosure.

In order to more clearly illustrate the technical solutions in the embodiments of the present disclosure or in the prior art, the accompanying drawings for describing the embodiments or the prior art will be briefly described below. Apparently, those of ordinary skill in the art may still derive other drawings from these accompanying drawings without creative efforts.

FIG. 1 is a flowchart of an image erasing method according to an embodiment of the present disclosure;

FIG. 2 to FIG. 9 are schematic diagrams of various layers during execution of an image erasing method according to embodiments of the present disclosure;

FIG. 10 is a schematic diagram of a structure of an image erasing apparatus according to an embodiment of the present disclosure; and

FIG. 11 is a schematic diagram of a structure of an electronic device according to an embodiment of the present disclosure.

### DETAILED DESCRIPTION OF EMBODIMENTS

For a clearer understanding of the above objectives, features and advantages of the present disclosure, the solutions of the present disclosure will be further described below. It should be noted that the embodiments of the present disclosure and features in the embodiments may be combined with each other without conflict.

Many specific details are set forth in the following description to facilitate a full understanding of the present disclosure. However, the present disclosure may also be implemented in other ways different from those described herein. Apparently, the embodiments in the description are only some rather than all of the embodiments of the present disclosure.

In the actual image processing process, users, in pursuit of innovation and personality expression, often use layer material to carry out creative retouching, such that various effects of layers, such as textures, light, patterns or other image components, can be overlaid or blended while preserving core elements of the original image, thereby enriching visual content and creating unique visual effects.

However, a crucial step in the workflow of creative retouching is image erasing. This step is intended to remove unwanted parts of an image so that the image can be cleanly incorporated into a new background or element.

To solve the above technical problem or at least partially solve the above technical problem, the present disclosure provides an image erasing method, an apparatus, an electronic device, and a storage medium.

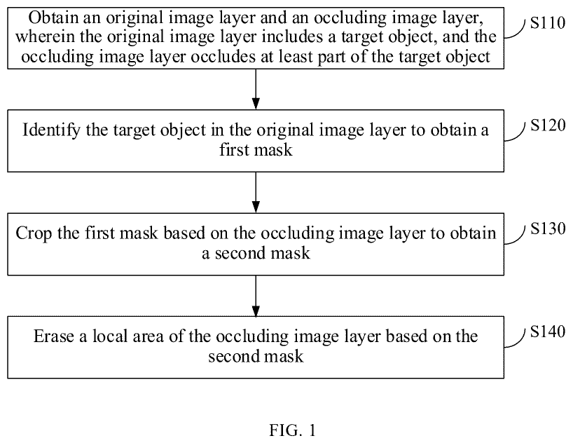

FIG. 1 is a flowchart of an image erasing method according to an embodiment of the present disclosure. This embodiment is applicable to image erasure in a client. The method may be performed by an image erasing apparatus. The apparatus may be implemented in the form of software and/or hardware, and may be configured in an electronic device, for example, a terminal, specifically including, but not limited to a smartphone, a palmtop computer, a tablet computer, a wearable device with a display screen, a desktop computer, a notebook computer, an all-in-one machine, a smart home device, etc. Alternatively, this embodiment is applicable to image erasure in a server. The method may be performed by an image erasing apparatus. The apparatus may be implemented in the form of software and/or hardware, and may be configured in an electronic device, for example, a server.

As shown in FIG. 1, the method may specifically include the following steps.
S110: Obtain an original image layer and an occluding image layer, wherein the original image layer includes a target object, and the occluding image layer occludes at least part of the target object.

An original image may be, for example, an image that requires at least a partial area to be revealed. The original image may be an image captured by a user or an image downloaded from a network. The original image includes one or more objects, which are things in the original image, and specifically, may be persons, animals, plants, buildings, or objects, etc. The target object may be, for example, a specific object or objects in the original image, which are a major factor to be considered in determining an area to be erased in the image. The original image layer may be, for example, a layer on which the original image is located.

An occluding image may be, for example, an image that occludes the original image, and is the object to be erased. The occluding image may be, for example, an image captured by a user or an image downloaded from a network. The occluding image layer may be, for example, the layer on which the occluding image is located. A size of the occluding image may be greater than, equal to, or less than that of the original image. The occluding image may partially or completely occlude the target object in the original image.

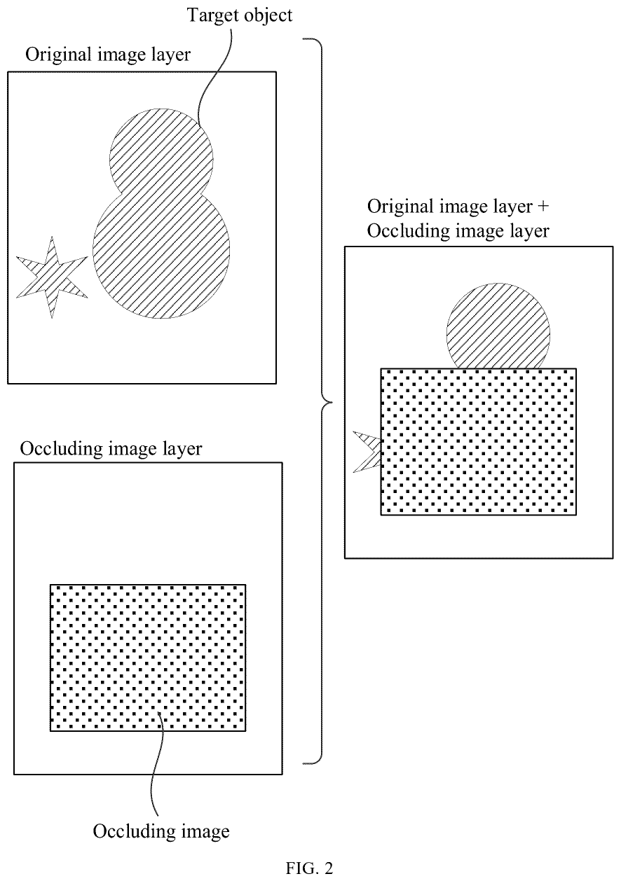

For example, referring to FIG. 2, an original image layer includes a hexangular star pattern, and a gourd-shaped pattern that is a target object, and an occluding image layer includes an occluding image that is rectangular. After the occluding image layer overlaps the original image layer, the occluding image occludes the lower half of the target object.

It should be noted that in practice, which layer acts as the occlusion layer, which layer acts as the original image layer, and which object or objects in the original image layer act as the target object may be specified by a user.
S120: Identify the target object in the original image layer to obtain a first mask.

The first mask indicates a position of the target object in the original image layer.

Optionally, an object identification model may be used to identify the target object in the original image layer, to obtain the first mask. For example, if the target object is a person, a person identification model may be used; or if the target object is an animal, an animal identification model may be used.

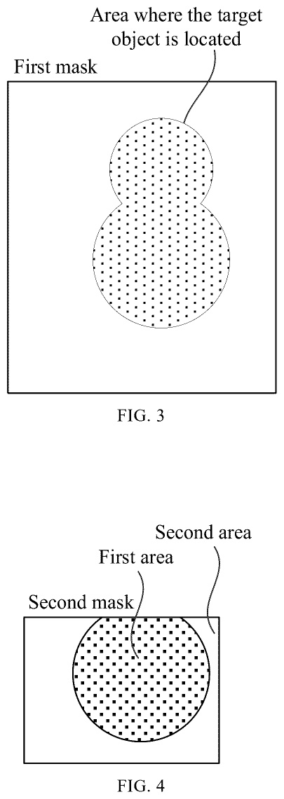

For example, for the original image layer shown in FIG. 2, a first mask is obtained by using the gourd-shaped pattern as the target object. As shown in FIG. 3, the first mask indicates a position of the target object.
S130: Crop the first mask based on the occluding image layer to obtain a second mask.

This step can be implemented by many methods, which is not limited in the present application. For example, an implementation method for this step includes: unifying the occluding image layer and the first mask into a same coordinate system, and cropping the first mask based on coordinate values of the occluding image layer and the first mask in the coordinate system.

It should be noted that in practice, in order to enable individual layers to be edited independently, it is generally provided that the layers have respective coordinate systems, and a canvas also has a coordinate system corresponding to the canvas. As a result, the coordinate system of the occluding image layer and the coordinate system of the first mask layer often do not exactly overlap. In practice, a rotation, a flip, horizontal or vertical axial scaling, etc. may exist between the two coordinate systems. In view of this, optionally, it may be provided that an implementation method for this step includes: using the coordinate system corresponding to the occluding image layer as a target coordinate system; placing the first mask in the target coordinate system; and cropping the first mask based on coordinate values of the occluding image layer and the first mask in the target coordinate system, to obtain the second mask. This provision can reduce the amount of computation of determining an area to be cropped, thereby improving the efficiency of cropping the first mask.

For example, a second mask obtained by cropping the first mask of FIG. 3 based on the occluding image in the occluding image layer of FIG. 2 is shown in FIG. 4. Referring to FIG. 4, the second mask includes a first area and a second area, wherein the first area at least partially overlaps the target object in the original image layer, and the second area is an area in the second mask other than the first area.
S140: Erase a local area of the occluding image layer based on the second mask.

Optionally, the second mask includes a first area and a second area, wherein the first area at least partially overlaps the target object in the original image layer, and the second area is an area in the second mask other than the first area. An implementation method of this step includes: erasing an image in an area of the occluding image layer corresponding to the first area, to reveal the target object in the original image layer from the first area; or erasing an image in an area of the occluding image layer corresponding to the second area, such that the occluding image layer occludes only the target object in the original image layer.

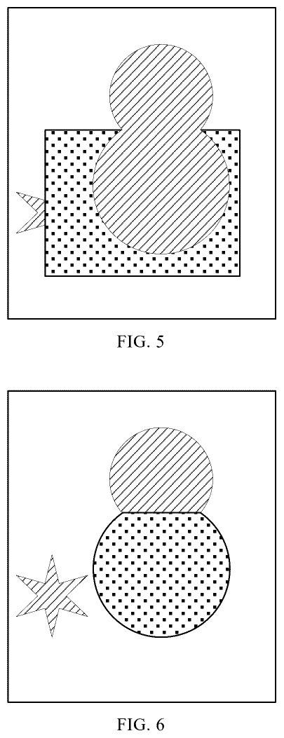

In essence, erasing an image in an area of the occluding image layer that corresponds to the first area is to use an image in the occluding image layer that is located in the first area as content to be erased. For example, it can be seen by comparing FIG. 2 and FIG. 5 that, after the image in the occluding image layer located in the first area is erased, the lower half of the gourd-shaped pattern in the original image layer is displayed.

In essence, erasing an image in an area of the occluding image layer that corresponds to the second area is to use an image in the occluding image layer that is located in the second area as content to be erased. For example, it can be seen by comparing FIG. 2 and FIG. 6 that, after the image in the occluding image layer located in the second area is erased, the lower half of the gourd-shaped pattern in the original image layer is still occluded, but the image in the occluding image layer other than the gourd-shaped pattern is removed,

In the above technical solution, the original image layer and the occluding image layer are obtained, wherein the original image layer includes a target object, and the occluding image layer occludes at least part of the target object; the target object in the original image layer is identified to obtain the first mask; the first mask is cropped based on the occluding image layer to obtain the second mask; and the local area of the occluding image layer is erased based on the second mask. In essence, in this way, a method that assists users in precisely determining an area to be erased and performing image erasing is provided. The method does not require the users to define, through painting, the area to be erased, which allows for high image erase efficiency. Moreover, through this method, the area to be erased is determined with high precision, thereby to some extent avoiding the occurrence of problems such as information loss and edge blur caused by imprecise determination of the area to be erased.

On the basis of the above technical solution, optionally, after S140, the method may further include: compositing the original image layer and the occluding image layer after erasing, to obtain the target image. In some scenarios, after erasing operation, the occluding image layer and the original image layer themselves may be used as a result of creative retouching, and may be subsequently saved, displayed or propagated.

In the above technical solution, optionally, S120 may alternatively be replaced by: obtaining a first candidate image layer; merging the first candidate image layer with the original image layer to obtain a target layer; and identifying the target object in the target layer to obtain the first mask.

The first candidate image layer may be, for example, a user-specified layer. Optionally, the first candidate image layer may be, for example, layers on the current display interface (for example, a canvas currently displayed by a terminal) other than the original image layer and the occluding image layer.

The first candidate image layer is merged with the original image layer to obtain the target layer, and the target object in the target layer is identified to obtain the first mask, the essence of which is to allow further definition of the extent to be erased, by means of the first candidate image layer.

Further, there is a stacking relationship between the first candidate image layer and the occluding image layer; and merging the first candidate image layer with the original image layer to obtain the target layer may include: determining a second candidate image layer in the first candidate image layer based on the stacking relationship between the first candidate image layer and the occluding image layer, wherein the second candidate image layer is located below the occluding image layer; and merging the second candidate image layer with the original image layer to obtain the target layer.

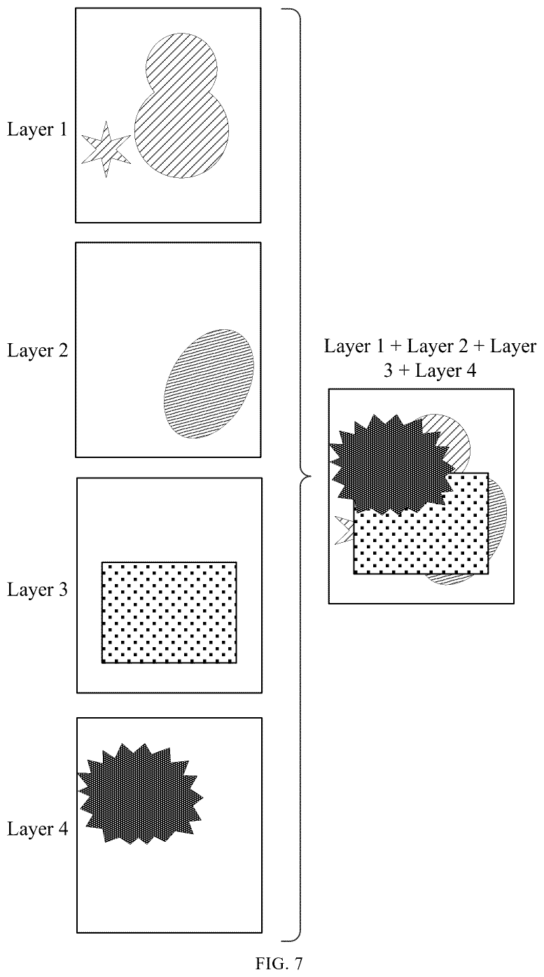

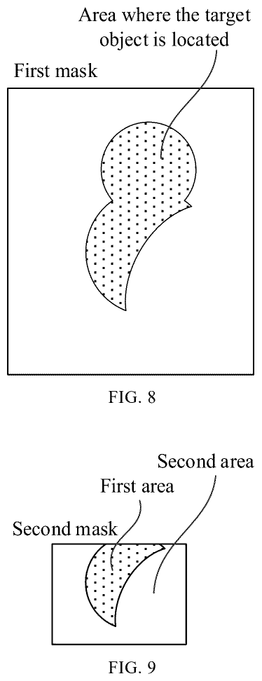

For example, referring to FIG. 7, it is assumed that a terminal displays a total of 4 layers in a canvas, which are respectively layer 1 to layer 4 from bottom to top. Layer 1 is an original image layer, and layer 3 is an occluding image layer. Layer 2 and layer 4 are both first candidate image layers. layer 2 is located below layer 3, that is, between layer 1 and layer 3. Layer 4 is located above layer 3. Thus, layer 2 is a second candidate image layer. During subsequent target object identification, a first mask is obtained by identifying the whole of layer 1 and layer 2. The first mask is shown in FIG. 8. Then, the first mask is cropped based on the occluding image layer (layer 3) to obtain a second mask. The second mask is shown in FIG. 9.

On the basis of the above technical solutions, optionally, the method may further include: determining target pixels based on the target object; determining a ratio of a number of the target pixels within a third area to a total number of pixels within the third area, wherein the third area is an area obtained by projecting the first mask into the original image; and determining, based on the ratio, whether the target object is identified successfully; and S130 includes: if a determination result is that the target object is identified successfully, cropping the first mask based on the occluding image layer to obtain the second mask.

The target pixels are pixels associated with the target object, and a number of target pixels can be used to some extent to determine whether the resulting first mask really indicates a position of the target object. For example, in the case where the target object is a white cat, if the target object is identified correctly, it means that a ratio of a number of white pixels within the third area to the total number of pixels within the third area is large. It is determined that the target pixels are white.

The step “determining, based on the ratio, whether the target object is identified successfully” can be implemented by many methods, which is not limited in the present application. For example, the implementation method for this step may include determining, based on a size relationship between the ratio and a preset threshold, whether the target object is identified successfully. The preset threshold may be set according to actual needs, which is not limited in the present application.

In practice, the target object identification model is not perfect, and a variety of identification errors may occur: For example, one object may be erroneously identified as another object; no target object is identified although there is a target object in an original image; background noise or a random pattern is considered as a target object although there is no target object in an original image, etc. In view of this, the ratio of the number of target pixels within the third area to the total number of pixels within the third area is determined, and it is determined whether the target object is identified successfully based on the ratio, the essence of which is to check the identification result, thereby further ensuring that the area to be erased is determined accurately.

It can be understood that before the use of the technical solutions disclosed in the embodiments of the present disclosure, the user shall be informed of the type, range of use, use scenarios, etc., of personal information involved in the present disclosure in an appropriate manner in accordance with the relevant laws and regulations, and the authorization of the user shall be obtained.

For example, in response to reception of an active request from the user, prompt information is sent to the user to clearly inform the user that a requested operation will require access to and use of the personal information of the user. As such, the user can independently choose, based on the prompt information, whether to provide the personal information to software or hardware, such as an electronic device, an application, a server, or a storage medium, that performs operations in the technical solutions of the present disclosure.

As an optional but non-limiting implementation, in response to the reception of the active request from the user, the prompt information may be sent to the user in the form of, for example, a pop-up window, in which the prompt information may be presented in text. Furthermore, the pop-up window may further include a selection control for the user to choose whether to “agree” or “disagree” to provide the personal information to the electronic device.

It can be understood that the above process of notifying and obtaining the authorization of the user is only illustrative and does not constitute a limitation on the implementations of the present disclosure, and other manners that satisfy the relevant laws and regulations may also be applied in the implementations of the present disclosure.

It should be noted that for ease of description, the foregoing method embodiments are described as a series of action combinations. However, those skilled in the art should understand that the present invention is not limited to the order of actions described, because some steps may be performed in another order or simultaneously according to the present invention. Moreover, those skilled in the art should also understand that the embodiments described in this specification are all preferred embodiments, and the involved actions and modules are not necessarily required in the present invention.

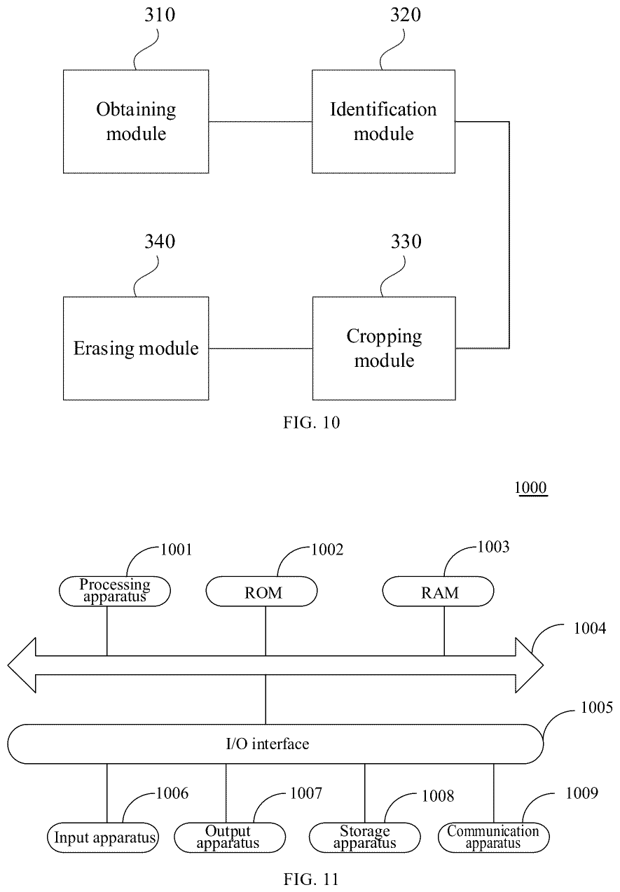

FIG. 10 is a schematic diagram of a structure of an image erasing apparatus according to an embodiment of the present disclosure. The image erasing apparatus provided in this embodiment of the present disclosure may be configured in a client, or in a server. Referring to FIG. 10, the image erasing apparatus specifically includes:
an obtaining module 310 configured to obtain an original image layer and an occluding image layer, wherein the original image layer includes a target object, and the occluding image layer occludes at least part of the target object;
an identification module 320 configured to identify the target object in the original image layer to obtain a first mask;
a cropping module 330 configured to crop the first mask based on the occluding image layer to obtain a second mask; and
an erasing module 340 configured to erase a local area of the occluding image layer based on the second mask.

Further, the identification module 320 is configured to:
obtain a first candidate image layer;
merge the first candidate image layer with the original image layer to obtain a target layer; and
identify the target object in the target layer to obtain the first mask.

Further,
there is a stacking relationship between the first candidate image layer and the occluding image layer; and the identification module 320 is configured to:
determine a second candidate image layer in the first candidate image layer based on the stacking relationship between the first candidate image layer and the occluding image layer, wherein the second candidate image layer is located below the occluding image layer; and
merge the second candidate image layer with the original image layer to obtain the target layer.

Further, the cropping module 330 is configured to:
use a coordinate system corresponding to the occluding image layer as a target coordinate system;
place the first mask in the target coordinate system; and
crop the first mask based on coordinate values of the occluding image layer and the first mask in the target coordinate system, to obtain the second mask.

Further, the apparatus also includes a verification module. The verification module is configured to:
determine target pixels based on the target object;
determine a ratio of a number of the target pixels within a third area to a total number of pixels within the third area, wherein the third area is an area obtained by projecting the first mask into the original image; and
determine, based on the ratio, whether the target object is identified successfully; and
the cropping module 330 is configured to:
if a determination result is that the target object is identified successfully, crop the first mask based on the occluding image layer to obtain the second mask.

Further, the second mask includes a first area and a second area, wherein the first area at least partially overlaps the target object in the original image layer, and the second area is an area in the second mask other than the first area; and
The erasing module 340 is configured to:
erase an image in an area of the occluding image layer corresponding to the first area, to reveal the target object in the original image layer from the first area; or
erase an image in an area of the occluding image layer corresponding to the second area, such that the occluding image layer occludes only the target object in the original image layer.

Further, the apparatus also includes a compositing module. The compositing module is configured to:
composite the original image layer and the occluding image layer after erasing, to obtain the target image.

The image erasing apparatus provided in the embodiment of the present disclosure can perform the steps of the image erasing method provided in the method embodiment of the present disclosure, which are performed by the client or the server, and has execution steps and beneficial effects. Details are not described herein again.

FIG. 11 is a schematic diagram of a structure of an electronic device according to an embodiment of the present disclosure. Reference is made specifically to FIG. 11 below, which is a schematic diagram of a structure of an electronic device 1000 suitable for implementing the embodiments of the present disclosure. The electronic device 1000 in this embodiment of the present disclosure may include, but is not limited to, a mobile terminal such as a mobile phone, a notebook computer, a digital broadcast receiver, a personal digital assistant (PDA), a tablet computer (PAD), a portable multimedia player (PMP), a vehicle-mounted terminal (such as a vehicle navigation terminal), and a wearable electronic device, and a fixed terminal such as a digital TV, a desktop computer, and a smart home device. The electronic device shown in FIG. 11 is merely an example, and shall not impose any limitation on the function and scope of use of the embodiments of the present disclosure.

As shown in FIG. 11, the electronic device 1000 may include a processing apparatus (such as a central processing unit or a graphics processing unit) 1001 that may perform a variety of appropriate actions and processing in accordance with a program stored in a read-only memory (ROM) 1002 or a program loaded from a storage apparatus 1008 into a random access memory (RAM) 1003 to implement the image erasing method according to the embodiment of the present disclosure. The RAM 1003 further stores various programs and information required for the operation of the electronic device 1000. The processing apparatus 1001, the ROM 1002, and the RAM 1003 are connected to one another through a bus 1004. An input/output (I/O) interface 1005 is also connected to the bus 1004.

Generally, the following apparatuses may be connected to the I/O interface 1005: an input apparatus 1006 including, for example, a touchscreen, a touchpad, a keyboard, a mouse, a camera, a microphone, an accelerometer, and a gyroscope; an output apparatus 1007 including, for example, a liquid crystal display (LCD), a speaker, and a vibrator; the storage apparatus 1008 including, for example, a tape and a hard disk; and a communication apparatus 1009. The communication apparatus 1009 may allow the electronic device 1000 to perform wireless or wired communication with other devices to exchange information. Although FIG. 11 shows the electronic device 1000 having various apparatuses, it should be understood that it is not required to implement or have all of the shown apparatuses. It may be an alternative to implement or have more or fewer apparatuses.

In particular, according to an embodiment of the present disclosure, the process described above with reference to the flowchart may be implemented as a computer software program. For example, this embodiment of the present disclosure includes a computer program product, which includes a computer program carried on a non-transitory computer-readable medium, wherein the computer program includes program code for performing the method shown in the flowchart, to implement the above image erasing method. In such an embodiment, the computer program may be downloaded and installed from a network through the communication apparatus 1009, installed from the storage apparatus 1008, or installed from the ROM 1002. When the computer program is executed by the processing apparatus 1001, the above-mentioned functions defined in the method of the embodiment of the present disclosure are performed.

It should be noted that the above computer-readable medium described in the present disclosure may be a computer-readable signal medium, a computer-readable storage medium, or any combination thereof. The computer-readable storage medium may be, for example but not limited to, electric, magnetic, optical, electromagnetic, infrared, or semiconductor systems, apparatuses, or devices, or any combination thereof. More specific examples of the computer-readable storage medium may include, but are not limited to: an electrical connection having one or more wires, a portable computer magnetic disk, a hard disk, a random access memory (RAM), a read-only memory (ROM), an erasable programmable read-only memory (EPROM) (or a flash memory), an optical fiber, a portable compact disc read-only memory (CD-ROM), an optical storage device, a magnetic storage device, or any suitable combination thereof. In the present disclosure, the computer-readable storage medium may be any tangible medium containing or storing a program which may be used by or in combination with an instruction execution system, apparatus, or device. In the present disclosure, the computer-readable signal medium may include an information signal propagated in a baseband or as a part of a carrier, in which a computer-readable program code is carried. The propagated information signal may be in various forms, including but not limited to an electromagnetic signal, an optical signal, or any suitable combination thereof. The computer-readable signal medium may further be any computer-readable medium other than the computer-readable storage medium. The computer-readable signal medium can send, propagate, or transmit a program used by or in combination with an instruction execution system, apparatus, or device. The program code contained in the computer-readable medium may be transmitted by any suitable medium, including but not limited to: electric wires, optical cables, radio frequency (RF), etc., or any suitable combination thereof.

In some implementations, the client and the server may communicate using any known or future-developed network protocol such as a Hypertext Transfer Protocol (HTTP), and may be connected to digital information communication (for example, communication network) in any form or medium. Examples of the communication network include a local area network (“LAN”), a wide area network (“WAN”), an internetwork (for example, the Internet), a peer-to-peer network (for example, an ad hoc peer-to-peer network), and any known or future-developed network.

The above computer-readable medium may be contained in the above electronic device. Alternatively, the computer-readable medium may exist independently, without being assembled into the electronic device.

The above computer-readable medium carries one or more programs that, when executed by the electronic device, cause the electronic device to:
obtain an original image layer and an occluding image layer, wherein the original image layer includes a target object, and the occluding image layer occludes at least part of the target object;
identify the target object in the original image layer to obtain a first mask;
crop the first mask based on the occluding image layer to obtain a second mask; and
erase a local area of the occluding image layer based on the second mask.

Optionally, when the one or more programs are executed by the electronic device, the electronic device may also perform other steps described in the above embodiments.

Computer program code for performing operations of the present disclosure can be written in one or more programming languages or a combination thereof, wherein the programming languages include but are not limited to object-oriented programming languages, such as Java, Smalltalk, and C++, and further include conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the case of the remote computer, the remote computer may be connected to the computer of the user through any kind of network, including a local area network (LAN) or a wide area network (WAN), or may be connected to an external computer (for example, connected through the Internet with the aid of an Internet service provider).

The flowchart and block diagram in the accompanying drawings illustrate the possibly implemented architecture, functions, and operations of the system, method, and computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the accompanying drawings. For example, two blocks shown in succession can actually be performed substantially in parallel, or they can sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The related units described in the embodiments of the present disclosure may be implemented by software, or may be implemented by hardware. The name of a unit does not constitute a limitation on the unit itself under certain circumstances.

The functions described herein above may be performed at least partially by one or more hardware logic components. For example, without limitation, exemplary types of hardware logic components that may be used include: a field programmable gate array (FPGA), an application-specific integrated circuit (ASIC), an application-specific standard product (ASSP), a system-on-chip (SOC), a complex programmable logic device (CPLD), and the like.

In the context of the present disclosure, a machine-readable medium may be a tangible medium that may contain or store a program used by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM) (or a flash memory), an optic fiber, a portable compact disc read-only memory (CD-ROM), an optical storage device, a magnetic storage device, or any suitable combination thereof.

According to one or more embodiments of the present disclosure, the present disclosure provides an electronic device. The electronic device includes:
one or more processors; and
a memory configured to store one or more programs, where
the one or more programs, when executed by the one or more processors, cause the one or more processors to implement any one of the image erasing methods according to the present disclosure.

According to one or more embodiments of the present disclosure, the present disclosure provides a computer-readable storage medium having a computer program stored thereon, wherein the program, when executed by a processor, causes any one of the image erasing methods provided in the present disclosure to be implemented.

An embodiment of the present disclosure further provides a computer program product, including a computer program or instruction that, when executed by a processor, causes the above image erasing method to be implemented.

It should be noted that the relational terms such as “first” and “second” herein are only used to distinguish one entity or operation from another, and do not necessarily require or imply that any actual relationship or sequence exists between these entities or operations. Moreover, the terms “include” and “comprise”, or any of their variants are intended to cover a non-exclusive inclusion, such that a process, method, article, or device that includes a list of elements not only includes those elements but also includes other elements that are not expressly listed, or further includes elements inherent to such process, method, article, or device. In the absence of more restrictions, an element defined by “including/comprising a/an . . . ” does not exclude another identical element in a process, method, article, or device that includes the element.

The above description illustrates merely specific implementations of the present disclosure, such that a person skilled in the art can understand or implement the present disclosure. Various modifications to these embodiments are apparent to a person skilled in the art, and the general principle defined herein may be practiced in other embodiments without departing from the spirit or scope of the present disclosure. Therefore, the present disclosure is not limited to the embodiments described herein but is to be accorded the broadest scope consistent with the principle and novel features disclosed herein.

I/We claim:

1. An image erasing method, comprising:
obtaining an original image layer and an occluding image layer, wherein the original image layer comprises a target object, and the occluding image layer occludes at least part of the target object;
identifying the target object in the original image layer to obtain a first mask;
cropping the first mask based on the occluding image layer to obtain a second mask; and
erasing a local area of the occluding image layer based on the second mask.

2. The method according to claim 1, wherein identifying the target object in the original image layer to obtain the first mask comprises:
obtaining a first candidate image layer;
merging the first candidate image layer with the original image layer to obtain a target layer; and
identifying the target object in the target layer to obtain the first mask.

3. The method according to claim 2, wherein there is a stacking relationship between the first candidate image layer and the occluding image layer, and merging the first candidate image layer with the original image layer to obtain the target layer comprises:
determining a second candidate image layer in the first candidate image layer based on the stacking relationship between the first candidate image layer and the occluding image layer, wherein the second candidate image layer is located below the occluding image layer; and
merging the second candidate image layer with the original image layer to obtain the target layer.

4. The method according to claim 1, wherein cropping the first mask based on the occluding image layer comprises:
using a coordinate system corresponding to the occluding image layer as a target coordinate system;
placing the first mask in the target coordinate system; and
cropping the first mask based on coordinate values of the occluding image layer and the first mask in the target coordinate system, to obtain the second mask.

5. The method according to claim 1, further comprising:
determining target pixels based on the target object;
determining a ratio of a number of the target pixels within a third area to a total number of pixels within the third area, wherein the third area is an area obtained by projecting the first mask into the original image; and
determining, based on the ratio, whether the target object is identified successfully; and
cropping the first mask based on the occluding image layer to obtain the second mask comprises:
if a determination result is that the target object is identified successfully, cropping the first mask based on the occluding image layer to obtain the second mask.

6. The method according to claim 1, wherein the second mask comprises a first area and a second area, wherein the first area at least partially overlaps the target object in the original image layer, and the second area is an area in the second mask other than the first area, and erasing the local area of the occluding image layer based on the second mask comprises:
erasing an image in an area of the occluding image layer corresponding to the first area, to reveal the target object in the original image layer from the first area; or
erasing an image in an area of the occluding image layer corresponding to the second area, such that the occluding image layer occludes only the target object in the original image layer.

7. The method according to claim 1, wherein after erasing the local area of the occluding image layer based on the second mask, the method further comprises:
compositing the original image layer and the occluding image layer after erasing, to obtain the target image.

8. An electronic device, comprising:
one or more processors; and
a storage apparatus configured to store one or more programs, wherein
the one or more programs, when executed by the one or more processors, cause the one or more processors to implement an image erasing method comprising:
obtaining an original image layer and an occluding image layer, wherein the original image layer comprises a target object, and the occluding image layer occludes at least part of the target object;
identifying the target object in the original image layer to obtain a first mask;
cropping the first mask based on the occluding image layer to obtain a second mask; and
erasing a local area of the occluding image layer based on the second mask.

9. The electronic device according to claim 8, wherein identifying the target object in the original image layer to obtain the first mask comprises:
obtaining a first candidate image layer;
merging the first candidate image layer with the original image layer to obtain a target layer; and
identifying the target object in the target layer to obtain the first mask.

10. The electronic device according to claim 9, wherein there is a stacking relationship between the first candidate image layer and the occluding image layer, and merging the first candidate image layer with the original image layer to obtain the target layer comprises:
determining a second candidate image layer in the first candidate image layer based on the stacking relationship between the first candidate image layer and the occluding image layer, wherein the second candidate image layer is located below the occluding image layer; and
merging the second candidate image layer with the original image layer to obtain the target layer.

11. The electronic device according to claim 8, wherein cropping the first mask based on the occluding image layer comprises:
using a coordinate system corresponding to the occluding image layer as a target coordinate system;
placing the first mask in the target coordinate system; and
cropping the first mask based on coordinate values of the occluding image layer and the first mask in the target coordinate system, to obtain the second mask.

12. The electronic device according to claim 8, wherein the method further comprises:
determining target pixels based on the target object;
determining a ratio of a number of the target pixels within a third area to a total number of pixels within the third area, wherein the third area is an area obtained by projecting the first mask into the original image; and
determining, based on the ratio, whether the target object is identified successfully; and
cropping the first mask based on the occluding image layer to obtain the second mask comprises:
if a determination result is that the target object is identified successfully, cropping the first mask based on the occluding image layer to obtain the second mask.

13. The electronic device according to claim 8, wherein the second mask comprises a first area and a second area, wherein the first area at least partially overlaps the target object in the original image layer, and the second area is an area in the second mask other than the first area, and erasing the local area of the occluding image layer based on the second mask comprises:
erasing an image in an area of the occluding image layer corresponding to the first area, to reveal the target object in the original image layer from the first area; or
erasing an image in an area of the occluding image layer corresponding to the second area, such that the occluding image layer occludes only the target object in the original image layer.

14. The electronic device according to claim 8, wherein after erasing the local area of the occluding image layer based on the second mask, the method further comprises:
compositing the original image layer and the occluding image layer after erasing, to obtain the target image.

15. A non-transitory computer-readable storage medium having a computer program stored thereon, wherein the program, when executed by a processor, implements an image erasing method comprising:
obtaining an original image layer and an occluding image layer, wherein the original image layer comprises a target object, and the occluding image layer occludes at least part of the target object;
identifying the target object in the original image layer to obtain a first mask;
cropping the first mask based on the occluding image layer to obtain a second mask; and
erasing a local area of the occluding image layer based on the second mask.

16. The non-transitory computer-readable storage medium according to claim 15, wherein identifying the target object in the original image layer to obtain the first mask comprises:
obtaining a first candidate image layer;
merging the first candidate image layer with the original image layer to obtain a target layer; and
identifying the target object in the target layer to obtain the first mask.

17. The non-transitory computer-readable storage medium according to claim 16, wherein there is a stacking relationship between the first candidate image layer and the occluding image layer, and merging the first candidate image layer with the original image layer to obtain the target layer comprises:
determining a second candidate image layer in the first candidate image layer based on the stacking relationship between the first candidate image layer and the occluding image layer, wherein the second candidate image layer is located below the occluding image layer; and
merging the second candidate image layer with the original image layer to obtain the target layer.

18. The non-transitory computer-readable storage medium according to claim 15, wherein cropping the first mask based on the occluding image layer comprises:
using a coordinate system corresponding to the occluding image layer as a target coordinate system;
placing the first mask in the target coordinate system; and
cropping the first mask based on coordinate values of the occluding image layer and the first mask in the target coordinate system, to obtain the second mask.

19. The non-transitory computer-readable storage medium according to claim 15, wherein the method further comprises:
determining target pixels based on the target object;
determining a ratio of a number of the target pixels within a third area to a total number of pixels within the third area, wherein the third area is an area obtained by projecting the first mask into the original image; and
determining, based on the ratio, whether the target object is identified successfully; and
cropping the first mask based on the occluding image layer to obtain the second mask comprises:
if a determination result is that the target object is identified successfully, cropping the first mask based on the occluding image layer to obtain the second mask.

20. The non-transitory computer-readable storage medium according to claim 15, wherein the second mask comprises a first area and a second area, wherein the first area at least partially overlaps the target object in the original image layer, and the second area is an area in the second mask other than the first area, and erasing the local area of the occluding image layer based on the second mask comprises:
erasing an image in an area of the occluding image layer corresponding to the first area, to reveal the target object in the original image layer from the first area; or
erasing an image in an area of the occluding image layer corresponding to the second area, such that the occluding image layer occludes only the target object in the original image layer.
